(19) United States
(12) Patent Application Publication
(10) Pub. No.: US 2025/0370829 A1
(43) Pub. Date: Dec. 4, 2025

(54) API Recommendations Based on Performance Metrics

(71) Applicant: eBay Inc., San Jose, CA (US)

(72) Inventors: Nataraj Agaram Sundar, Santa Clara, CA (US); Hari Narayanan Rangarajan, San Jose, CA (US); Tejas Morabia, Fremont, CA (US)

(73) Assignee: eBay Inc., San Jose, CA (US)

(21) Appl. No.: 18/679,299

(22) Filed: May 30, 2024

(51) Int. Cl. G06F 9/54

(52) U.S. Cl. CPC G06F 9/541

(57) ABSTRACT

API recommendations based on performance metrics are described. In one or more implementations, an API recommendation system receives a request from a client device. Based on a condition of the request, the API recommendation system selects an application programming interface (API) of a plurality of APIs for performance of the request and stores performance metrics related to the performance of the request by the API in a performance index. The API recommendation system then receives a subsequent request and, using a machine learning model, determines a recommendation on calling the API for performance of the subsequent request by analyzing the performance metrics in the performance index. The API recommendation system then outputs instructions for performing the recommendation on calling the API.

### BACKGROUND

An application programming interface (API) is a set of protocols, tools, and definitions that facilitate communication between different software applications. APIs are employed to allow access to specific features or data from a software application, such as various operating system, payment, database, or cloud service features. Because APIs incorporate features into software applications without re-writing code to produce the features, APIs are also valuable because they allow complex services to be easily integrated into software applications. The competitive landscape and rising user expectations for complex interactions involving software application features compel e-commerce platforms to continually improve and innovate in this area to stay competitive by managing features implemented through APIs.

### SUMMARY

API recommendations based on performance metrics are described. In an implementation, an API recommendation system is configured to receive request from a client device. Based on a condition of the request, the API recommendation system is configured to select an API of a plurality of APIs for performance of the request and store performance metrics related to the performance of the request by the API in a performance index. In one or more examples, the performance metrics measure response success, system stability, error rate, or load capacity related to the performance of the request by the API.

The API recommendation system is configured to receive a subsequent request and to determine, using a machine learning model, a recommendation on calling the API for performance of the subsequent request by analyzing the performance metrics in the performance index. In one or more examples, the API recommendation system is configured to use the machine learning model to adjust weights of the performance metrics based on a condition of the subsequent request. For example, the machine learning model is trained on selections of APIs based on varied weights of the performance metrics for performance of previous requests. The API recommendation system is then configured to output instructions for performing the recommendation on calling the API.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of a digital medium environment in an example implementation that is operable to employ API recommendations based on performance metrics techniques described herein.

FIG. 2 depicts an example of a second API based on performance metrics for a first API.

FIG. 3 depicts an example of an API performance index for API recommendations based on performance metrics.

FIG. 4 depicts an example of generating weights for performance metrics for API recommendations.

FIG. 5 depicts an example of adjusting weights for performance metrics for API recommendations.

FIG. 6 depicts an example of training one or more machine learning models for API recommendations based on performance metrics.

FIG. 7 is a flow diagram depicting an algorithm as a step-by-step procedure in an example of implementing API recommendations based on performance metrics.

FIG. 8 is a flow diagram depicting an algorithm as a step-by-step procedure in an additional example of implementing API recommendations based on performance metrics.

FIG. 9 is a flow diagram depicting an algorithm as a step-by-step procedure in an additional example of implementing API recommendations based on performance metrics.

FIG. 10 illustrates an example system including various components of an example device that can be implemented as any type of computing device as described and/or utilized with reference to FIGS. 1-9 to implement embodiments of the techniques described herein.

### DETAILED DESCRIPTION

### Overview

Application programming interfaces (APIs) are used by vendor management platforms to interact with various applications. For example, an API facilitates retrieving or publishing information in an external database, ensuring that the vendor management platform has up-to-date contact details, contract information, pricing, and inventory levels. Additionally, the API allows the vendor management platform to access features from another application, thereby incorporating complex functionalities into the vendor management platform without encoding the features directly into the vendor management platform. A variety of APIs are available that serve specific purposes, including Operating System APIs, Payment APIs, Database APIs, or Cloud service APIs.

Although conventional API techniques allow for interaction between applications, a user manually determines which API to use for a specific client request, which is time-consuming and introduces human-caused error into an API selection. Additionally, in situations involving an underperforming API, the conventional API techniques do not allow for automatic replacement of the underperforming API with a different API. Using an inefficient API, for instance, results in slow applications, leading to low user conversion on vendor management platforms in particular.

Accordingly, techniques and systems are described for API recommendations based on performance metrics that address these limitations. An API recommendation system begins in this example by receiving a request from a client device to perform an action involving an API. The request indicates conditions that specify parameters for performance of the action, which involves an interaction with another application using the API.

The API recommendation system uses a machine learning model to select a first API for the performance of the action specified by the conditions of the request. To do this, the machine learning model determines a type of the request based on the conditions to pair with a type of an API. Different conditions, for instance, involve parameters related to different types of APIs. The Operating System APIs provide a way for software applications to interact with an operating system. The Database APIs allow applications to fetch and store information in databases. The Payment APIs enable online payment processing. Cloud Service APIs allow for management and interaction with cloud services. The API recommendation system selects a first API that has a type corresponding to the type of the request.

In one example, conditions of the request call for interacting with a feature of an operating system. Based on the conditions, the machine learning model determines that the Operating System API is appropriate for performing the request. In another example, the conditions of the request call for storing data in a database. Based on the conditions, the machine learning model determines that the Database API is appropriate for performing the request.

After calling the first API to perform the action specified by the conditions of the request, the API recommendation system collects performance metrics for storage in an API performance index related to performance of the action of the request by the first API. To do this, the API recommendation system analyzes API call events in real time. Examples of the performance metrics include response success, system stability, error rate, load capacity, or other metrics related to performance of the request by the first API.

The API recommendation system then receives a subsequent request to perform a subsequent action involving an API. The subsequent request may be similar or different from the first request, and indicates subsequent conditions that specify parameters for performance of the subsequent action. To select a second API to perform the subsequent request, the API recommendation system uses the machine learning model to analyze the performance metrics for the first API. For instance, the machine learning model determines whether the response success, the system stability, the error rate, or the load capacity for the first API meets a threshold level of performance.

To determine whether to use the first API or a different API to perform the subsequent request, the API recommendation system also assigns weights to individual performance metrics, indicating relevancy of the individual performance metrics to the request and the subsequent request. In an example, the API recommendation system determines that the error rate is more relevant to the subsequent request than the request and therefore weights the error rate as more relevant than other performance metrics for selection of the second API. Thus, the machine learning model determines a recommendation to call the second API to perform the subsequent request instead of calling first API a second time if the error rate for the first API fails to meet the threshold level of performance. In some examples, the machine learning model selects the second API in real time to replace usage of the first API, which is underperforming based on a predetermined metric.

Alternatively, the machine learning model determines that the response success, the system stability, the error rate, or the load capacity for the first API while performing the request meets the threshold level of performance. Thus, the machine learning model determines a recommendation to call the first API a second time instead of selecting a different API as the second API.

Determining a recommendation on calling an API for performance by analyzing the performance metrics in this manner overcomes the disadvantages of conventional API techniques that are limited to users manually selecting an API for a particular request. Additionally, because the machine learning model determines the recommendation on calling the API by analyzing the performance metrics in the performance index, the machine learning model is also configured to dynamically adjust API selection by identifying an underperforming API for replacement with a different API. For vendor management platforms, automatically selecting and calling APIs based on performance metrics allows for incorporation of complex features into the vendor management platforms, leading to increased conversion rates and user satisfaction.

In some aspects, the techniques described herein relate to a method, including: receiving a request from a client device, selecting an application programming interface (API) of a plurality of APIs for performance of the request based on a condition of the request, storing performance metrics related to the performance of the request by the API in a performance index, receiving a subsequent request, determining, using a machine learning model, a recommendation on calling the API for performance of the subsequent request by analyzing the performance metrics in the performance index, and outputting instructions for performing the recommendation on calling the API.

In some aspects, the techniques described herein relate to a method, wherein the machine learning model adjusts weights of the performance metrics based on a condition of the subsequent request.

In some aspects, the techniques described herein relate to a method, wherein the machine learning model is trained on selections of APIs based on varied weights of the performance metrics for performance of previous requests.

In some aspects, the techniques described herein relate to a method, further including updating the recommendation on calling the API for the performance of the subsequent request based on detecting whether the performance of the subsequent request meets a threshold level of performance.

In some aspects, the techniques described herein relate to a method, wherein the performance metrics measure response success, system stability, error rate, or load capacity related to the performance of the request by the API.

In some aspects, the techniques described herein relate to a method, further including analyzing events related to the performance of the request by the API to capture the performance metrics.

In some aspects, the techniques described herein relate to a method, further including determining a type of the API based on the condition of the request.

In some aspects, the techniques described herein relate to a method, wherein the recommendation on calling the API is based on a comparison between a condition of the subsequent request and the type of the API.

In some aspects, the techniques described herein relate to a method, wherein the recommendation on calling the API is based on a composite score of the performance metrics in the performance index.

In some aspects, the techniques described herein relate to a system including: a memory component, and a processing device coupled to the memory component, the processing device to perform operations including: receiving a request from a client device, selecting an application programming interface (API) of a plurality of APIs for performance of the request based on a condition of the request, storing performance metrics related to the performance of the request by the API in a performance index, and training a machine learning model to determine a recommendation on calling the API for performance of a subsequent request by analyzing the performance metrics in the performance index.

In some aspects, the techniques described herein relate to a system, further including training the machine learning model to adjust weights of the performance metrics based on a condition of the subsequent request.

In some aspects, the techniques described herein relate to a system, further including training the machine learning model on selections of APIs based on varied weights of the performance metrics for performance of previous requests.

In some aspects, the techniques described herein relate to a system, wherein the performance metrics measure response success, system stability, error rate, or load capacity related to the performance of the request by the API.

In some aspects, the techniques described herein relate to a system, further including analyzing events related to the performance of the request by the API to capture the performance metrics.

In some aspects, the techniques described herein relate to a system, further including determining a type of the API based on the condition of the request.

In some aspects, the techniques described herein relate to a system, wherein the recommendation on calling the API is based on a composite score of the performance metrics in the performance index.

In some aspects, the techniques described herein relate to a non-transitory computer-readable storage medium storing executable instructions, which when executed by a processing device, cause the processing device to perform operations including: selecting an application programming interface (API) of a plurality of APIs for performance of a request based on a condition of the request, maintaining a performance index by storing performance metrics related to the performance of the request by the API in the performance index, determining, using a machine learning model, a recommendation on calling the API for performance of a subsequent request by analyzing the performance metrics in the performance index, and outputting instructions for performing the recommendation on calling the API.

In some aspects, the techniques described herein relate to a non-transitory computer-readable storage medium, wherein the machine learning model adjusts weights of the performance metrics based on a condition of the subsequent request.

In some aspects, the techniques described herein relate to a non-transitory computer-readable storage medium, wherein the machine learning model is trained on selections of APIs based on varied weights of the performance metrics for performance of previous requests.

In some aspects, the techniques described herein relate to a non-transitory computer-readable storage medium, further including updating the recommendation on calling the API for the performance of the subsequent request based on detecting whether the performance of the subsequent request meets a threshold level of performance.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

### Example of an Environment

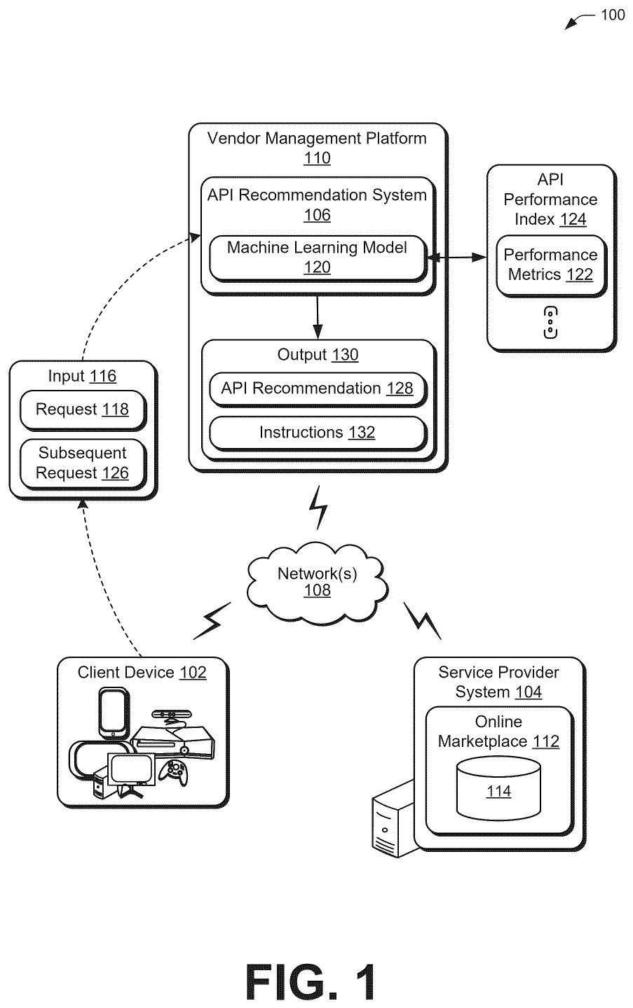

FIG. 1 is an illustration of an environment 100 in an example implementation that is operable to employ techniques described herein. The environment 100 includes a client device 102, a service provider system 104, and an application programming interface (API) recommendation system 106. In one or more implementations, the client device 102, the service provider system 104, and the API recommendation system 106 are communicatively coupled, one to another, via network(s) 108. One example of the network(s) 108 is the Internet, although one or more of the client device 102, the service provider system 104, and the API recommendation system 106 may be communicatively coupled using one or more different connections or different networks in various implementations.

Although the API recommendation system 106 is depicted in the environment 100 as being separate from the client device 102 and the service provider system 104, in one or more implementations, an entirety or various portions of the API recommendation system 106 are implemented at or by the client device 102 and/or the service provider system 104. In at least one implementation, for example, at least a portion of the API recommendation system 106 is computer-implemented by a vendor management platform 110 or other application of the client device 102 and/or using various resources of the client device 102, such as hardware resources, an operating system, firmware, and so forth. Alternatively or additionally, at least a portion of the API recommendation system 106 is implemented by resources (e.g., server-based storage, processing, and so on) of the service provider system 104. Alternatively or additionally, at least a portion of the API recommendation system 106 is implemented using a third-party service, such as a web services platform that provides one or more hardware and/or other computing resources to support provision of services by web service providers.

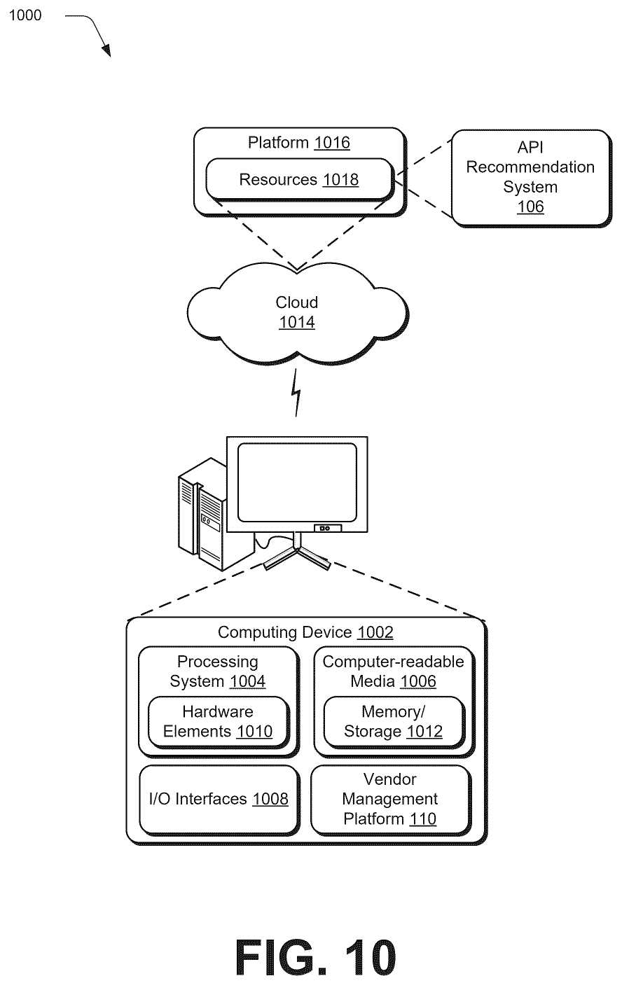

The client device 102 or other computing devices in the environment 100 are configurable in a variety of ways. The client device 102, for instance, is configurable as a desktop computer, a laptop computer, a mobile device (e.g., assuming a handheld configuration such as a tablet or mobile phone), an IoT device, a wearable device (e.g., a smart watch, a ring, or smart glasses), an AR/VR device (e.g., the smart glasses), a server, and so forth. Thus, the client device 102 ranges from full resource devices with substantial memory and processor resources to low-resource devices with limited memory and/or processing resources. Additionally, although in instances in the following discussion reference is made to a client device 102 or a computing device in the singular, the client device 102 or the computing device is also representative of a plurality of different devices, such as multiple servers of a server farm utilized to perform operations “over the cloud” as further described in relation to FIG. 10.

In at least one implementation, the vendor management platform 110 supports communication of data across the network(s) 108 between the client device 102 and the service provider system 104. By supporting such data communication, the vendor management platform 110 provides a respective user of the client device 102 (and users of other computing devices) access to an online marketplace 112. For example, the client device 102 receives data from the service provider system 104. Based on the received data, the vendor management platform 110 causes various systems of the client device 102 to output user interfaces of the online marketplace 112, such as by displaying user interfaces via display devices or making accessible voice-based user interfaces.

In the illustrated environment 100, the online marketplace 112 includes a storage device 114 that may represent one or more databases and/or other types of storage capable of storing API performance data. Examples of the storage device 114 include, but are not limited to, mass storage and virtual storage. In one or more implementations, for example, the storage device 114 may be virtualized across a plurality of data centers and/or cloud-based storage devices. The service provider system 104 may implement the online marketplace 112 by using servers that execute stored instructions to deploy various services of the service provider system 104, such that those servers perform numerous computations which are effective to provide the functionality described above and below. It is to be appreciated that the online marketplace 112 may include more, fewer, or different components without departing from the spirit or scope described herein. In one or more implementations, the online marketplace 112 is accessible by decentralized computing devices that correspond to “clients” of the online marketplace 112, e.g., users that have accounts with the online marketplace 112.

Broadly speaking, the online marketplace 112 is configured to generate listings for items and to expose those listings (e.g., publish them) to one or more computing devices, including the client device 102. For example, the online marketplace 112 may generate listings for items for sale and expose those listings to computing devices, such that the users of the computing devices can interact with the listings via user interfaces to initiate transactions (e.g., purchases, add to wish lists, share, and so on) in relation to the respective item or items of the listings. In accordance with the described techniques, the online marketplace 112 is configured to generate listings for one or more types of physical goods or property (e.g., clothing and/or clothing accessories, collectibles, furniture, decorative items, textiles, luxury items, electronics, real property, physical computer-readable storage having one or more video games stored thereon, and so on), services (e.g., babysitting, dog walking, house cleaning, and so on), digital items (e.g., digital images, digital music, digital videos) that can be downloaded via the network(s) 108, and blockchain backed assets (e.g., non-fungible tokens (NFTs)), to name just a few.

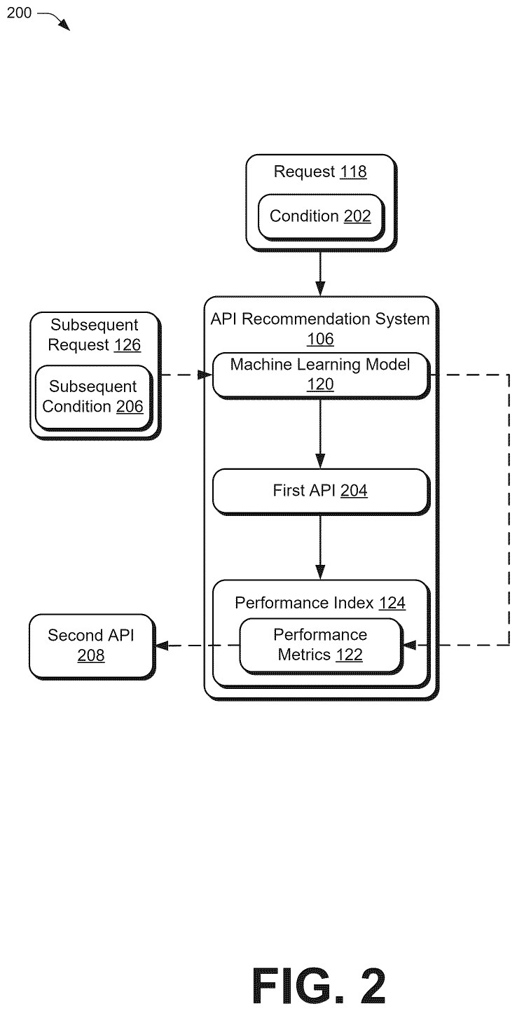

In the illustrated environment 100, the API recommendation system 106 receives an input 116 including a request 118 to perform an action related to the vendor management platform 110. Performance of the action involves an API, which acts as a bridge to allow different software applications to communicate and interact with each other. A variety of APIs are available to perform a multitude of tasks, including Web APIs, Operating System APIs, Database APIs, Payment APIs, Cloud Service APIs, or any other type of APIs, which are explained in further detail with respect to FIGS. 2-5. In one or more examples, the action specified by the request 118 involves the online marketplace 112, and an API is to be selected to facilitate interaction between the vendor management platform 110 and the online marketplace 112.

The request 118 specifies conditions for performance of the action. For instance, the request 118 involves a payment action and specifies conditions for performance of the payment action by the client device 102, including an operating system, security features, integration details, supported payment methods, geographic coverage, scalability, reliability, or other factors related to the performance of the payment action.

The API recommendation system 106 selects an API for performance of the request 118 based on the conditions for performance of the action. In this example, the API recommendation system 106 selects a Payment API over an Operating System API or a Database API, for instance, because the request 118 involves a payment action, and the Payment API satisfies the conditions for performance of the payment action over other available types of APIs. The API recommendation system 106 then calls the API to perform the action of the request 118.

Using a machine learning model 120, the API recommendation system 106 collects performance metrics 122 for the API in real time. After the API is called, the machine learning model 120 tracks events and analyzes results from performance of the API. The performance metrics 122 are specifically related to the action specified by the request, for instance, or are generally related to system performance. Examples of the performance metrics 122 include response success, system stability, error rate, or load capacity. The API recommendation system 106 maintains an API performance index 124 that stores the performance metrics 122 associated with the API. Data of the API performance index 124, for instance, is stored in memory of the storage device 114 or other location for access by the API recommendation system 106.

The API recommendation system 106 receives a subsequent request 126 to perform a subsequent action related to the vendor management platform 110, which is of a type or a different type from the action specified by the request 118. The subsequent request 126 also specifies conditions for performance of the subsequent action. In this example, the request 118 also involves the payment action and specifies conditions for performance of the payment action by the client device 102.

To determine whether to call the API again to perform the subsequent action specified by the subsequent request 126, the machine learning model 120 analyzes the performance metrics 122 related to performance of the API and determines an API recommendation 128 for calling the API or a different API. In this example, the machine learning model 120 determines that the response success, the system stability, the error rate, or the load capacity for the API while performing the action fails to meet a threshold level of performance. Thus, the machine learning model 120 determines a recommendation to call a different API to perform the subsequent request 126 instead of calling the API a second time.

The API recommendation system 106 then generates an output 130 including instructions 132 for the API recommendation 128. The instructions 132, for instance, identify the different API to call to perform the subsequent action of the subsequent request 126. In this example, because subsequent request 126 involves a payment action, and API recommendation system 106 identifies a different Payment API that satisfies the conditions for performance of the payment action over other available types of APIs, while improving the performance metrics 122.

Having considered an example of an environment, consider now a discussion of some example details of the techniques for API recommendations based on performance metrics in accordance with one or more implementations.

### API Recommendations Based on Performance Metrics

FIG. 2 depicts an example 200 of selecting a second API based on performance metrics for a first API. In the illustrated example 200, an API recommendation system 106 receives a request 118 to perform an action involving an API. The request 118 indicates a condition 202 or multiple conditions that specify parameters for performance of the action involving the API. The parameters, for instance, identify an API from a variety of APIs that are available to perform different tasks. For example, Web APIs allow communication over the internet using HTTP protocols, Operating System APIs provide a way for software application to interact with an operating system, Database APIs allow software applications to fetch and store information in databases, Payment APIs enable online payment processing, and Cloud Service APIs allow for management and interaction with cloud services. This example is not limited to these types of APIs, however, and the API recommendation system 106 is involved in selection of any type of API.

The API recommendation system 106 uses a machine learning model 120 to select a first API 204 for the performance of the action specified by the condition 202 of the request 118. The machine learning model 120 determines a type of the request 118 based on the condition 202. Different conditions, for instance, involve parameters related to different types of APIs. In one example, the condition 202 of the request 118 calls for storing data files of a certain size. Based on the condition 202, the machine learning model 120 determines that a Database API is appropriate for performing the request 118. In another example, the condition 202 of the request 118 calls for collecting payment information from a customer. Based on the condition 202, the machine learning model 120 determines that a Payment API is appropriate for performing the request 118. Based on the type of API identified for performing the request 118, the API recommendation system 106 then selects a first API 204 of the type. In some examples, the API recommendation system 106 selects the first API 204 based on prior usage of the first API 204, availability of the first API 204, additional qualifications of the first API 204 compared to the request 118, or other parameters of the first API 204.

After calling the first API 204 to perform the action specified by the condition 202 of the request 118, the API recommendation system 106 collects performance metrics 122 for storage in an API performance index 124 related to performance of the action of the request 118 by the first API 204. The API recommendation system 106 collects the performance metrics 122, for example, from Kafka Streams of the vendor management platform 110. The Kafka Streams constitute a processing library, which is a distributed streaming platform used for building streaming data pipelines and applications. The Kafka Streams include a client library for building applications and microservices where input data and output data are stored in Kafka clusters. For example, the API recommendation system 106 extracts or otherwise receives the performance metrics 122 from the Kafka Streams. In some examples, the API recommendation system 106 uses the machine learning model 120 to process data collected from the Kafka Streams to generate the performance metrics 122, including converting or organizing the performance metrics 122 into a format for storage in the API performance index 124.

The API recommendation system 106 then receives a subsequent request 126 to perform a subsequent action involving an API. The subsequent request 126 indicates a subsequent condition 206 or multiple subsequent conditions that specify parameters for performance of the subsequent action involving the API. A variety of APIs are also available to perform different tasks related to the subsequent request 126, including the Web APIs, the Operating System APIs, the Database APIs, the Payment APIs, the Cloud Service APIs, or any other type of API.

To select a second API 208 to perform the subsequent request 126, the API recommendation system 106 uses the machine learning model 120 to analyze the performance metrics 122 for the first API 204. For example, the machine learning model 120 determines that the response success, the system stability, the error rate, or the load capacity for the first API 204 while performing the request 118 fails to meet or is below a threshold level of performance. Thus, the machine learning model 120 determines a recommendation to call the second API 208 to perform the subsequent request 126 instead of calling first API 204 a second time. Alternatively, the machine learning model 120 determines that the response success, the system stability, the error rate, or the load capacity for the first API 204 while performing the request 118 meets or is above the threshold level of performance, or performs better than a predicted or known alternative API by comparing the performance metrics 122. Thus, the machine learning model 120 determines a recommendation to call the first API 204 a second time instead of selecting a different API as the second API 208. In some examples, the machine learning model 120 selects the second API 208 in real time to replace usage of the first API 204, which is underperforming based on a predetermined metric for comparing or analyzing the performance metrics 122.

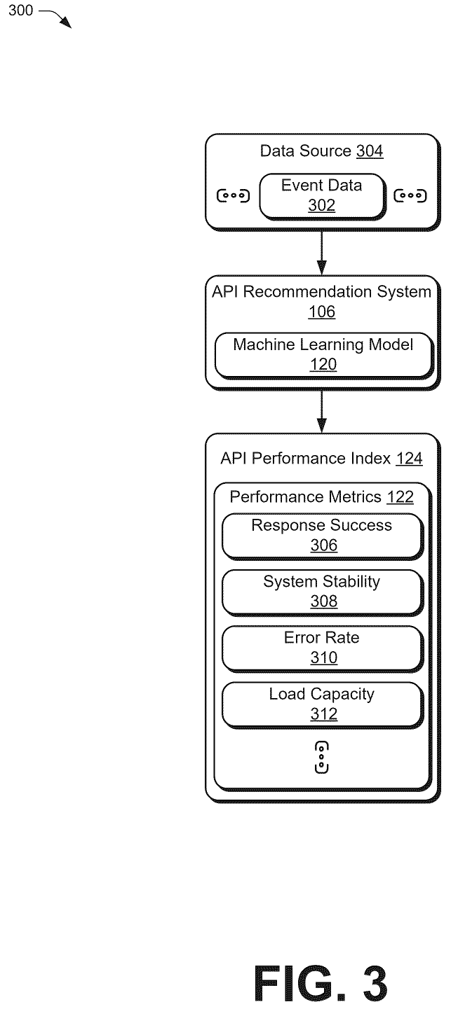

FIG. 3 depicts an example 300 of an API performance index for API recommendations based on performance metrics. Example 300 is a continuation of the example 200 described with respect to FIG. 2.

In the illustrated example 300, an API recommendation system 106 receives event data 302 from a data source 304 for building an API performance index 124. The event data 302 is data related to past or current events occurring in response to calling the first API 204 described with respect to FIG. 2. The event data 302, for instance, includes request metadata, response metadata, error data, user data, performance data, usage data, security data, integration data, or any other type of event data. Examples of the request metadata include a request timestamp, a request method, a request URL, request headers, or request parameters. Examples of the response metadata include a response status code, a response header, a response body, or a response time or latency. Examples of the error data include error status codes, exception messages, or stack traces. Examples of the user data include user permissions or other contextual information relevant to a session. Examples of the performance data include response time, throughput (number of requests per unit time), or error rate (number of failed requests). Examples of usage data include frequently called API endpoints, peak usage times, or geographic locations of API calls. Examples of the security data include IP addresses of clients, authorization tokens or keys, or presence of sensitive data exchanged. Examples of the integration data include events triggered by calling an API, integration endpoints, or success or failure of integration.

In some examples, the data source 304 is or includes Kafka Streams or another processing library that is a distributed streaming platform used for building streaming data pipelines and applications. The Kafka Streams include a client library for building applications and microservices where the input and output data are stored in Kafka clusters, facilitating real-time analytics monitoring for collecting the event data 302 or the data source 304.

Based on the event data 302, the API recommendation system 106 uses a machine learning model 120 to determine performance metrics 122 related to the event, including performance of the request 118 by the first API 204. Examples of the performance metrics 122 include response success 306, system stability 308, error rate 310, load capacity 312, or other metrics. For example, the API recommendation system 106 extracts or otherwise receives the event data 302 from the data source 304. In some examples, the API recommendation system 106 uses the machine learning model 120 to process the event data 302 collected to generate the performance metrics 122, including converting or organizing the performance metrics 122 into a format for storage in the API performance index 124. This includes converting raw data from the event data 302 into the response success 306, the system stability 308, the error rate 310, or the load capacity 312.

In some examples, the machine learning model 120 is a regression model that generates the performance metrics 122 from the event data 302 by predicting continuous outcomes based on input variables. The regression model is trained, for instance, on historical data containing various features related to API performance and corresponding performance metrics.

The API recommendation system 106 then generates the API performance index 124 including the performance metrics 122 of the response success 306, the system stability 308, the error rate 310, the load capacity 312, or other metrics. The API performance index 124 is stored in the storage device 114 in some examples for subsequent retrieval of the performance metrics 122 by the API recommendation system 106 to select the second API 208. Examples of the storage device 114 include, but are not limited to, mass storage and virtual storage. In one or more implementations, for example, the storage device 114 may be virtualized across a plurality of data centers and/or cloud-based storage devices.

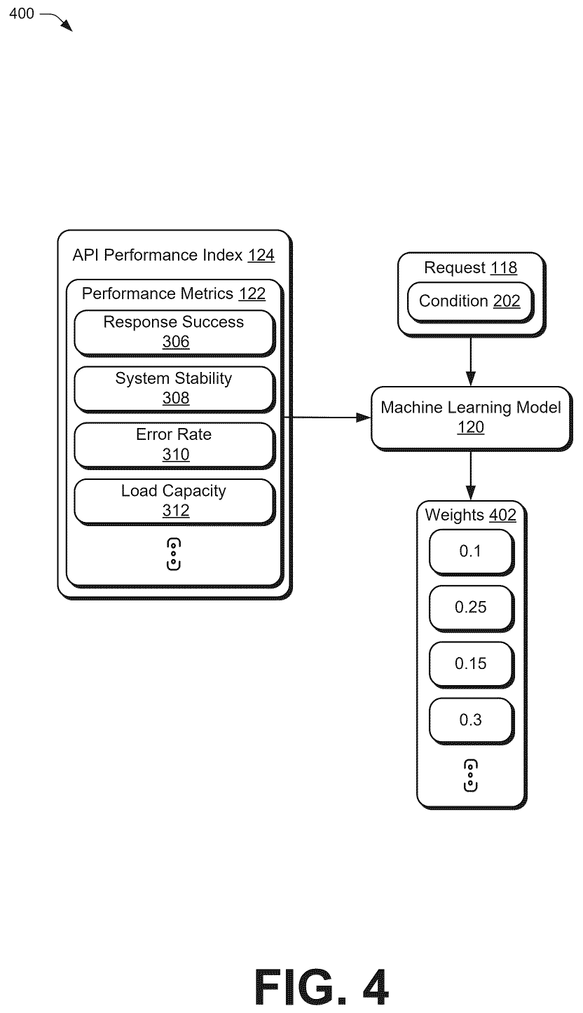

FIG. 4 depicts an example 400 of generating weights for performance metrics for API recommendations. Example 400 is a continuation of the example 300 described with respect to FIG. 3. After the API recommendation system 106 receives the performance metrics 122 from the API performance index 124, the API recommendation system 106 uses the machine learning model 120 to generate weights 402 corresponding to the performance metrics 122.

In the illustrated example 400, the performance metrics 122 include response success 306, system stability 308, error rate 310, and load capacity 312 related to recorded events involving performance of a request 118 by a first API 204. Different requests vary depending on conditions of the different requests. Based on the condition 202 of the request 118, the API recommendation system 106 determines the weights 402 corresponding to the performance metrics 122 that indicate a level or relevance or importance for the performance metrics 122.

In this example, the condition 202 of the request 118 calls for storing data files of a certain size. Based on the condition 202, the machine learning model 120 determines that the request 118 involves a Database API. Because the request involves the Database API, the machine learning model 120 ranks the system stability 308 and the load capacity 312 as more relevant than the response success 306 and the error rate 310 of the performance metrics 122. In this example, the machine learning model 120 assigns the weights 402 to the performance metrics 122, including 0.1 for the response success 306, 0.25 for the system stability 308, 0.15 for the error rate 310, and 0.3 for the load capacity 312, based on determined relative levels of importance. However, any rating or weighting system is contemplated for the performance metrics 122. The weights 402 are associated with the performance metrics 122 and stored for later recall by the API recommendation system 106 to select the second API 208.

In some examples, the API recommendation system 106 uses the machine learning model 120 to determine a composite score of the performance metrics 122 in the API performance index 124. To do this, the machine learning model 120 concatenates the performance metrics 122 based on the weights 402. For instance, the machine learning model 120 multiplies individual performance metrics of the performance metrics 122 by corresponding weights of the weights 402 and sums the results to obtain a single concatenated metric for the composite score. Additionally or alternatively, the machine learning model 120 uses a the target variable and the performance metrics 122 as input features to learn to predict the composite score.

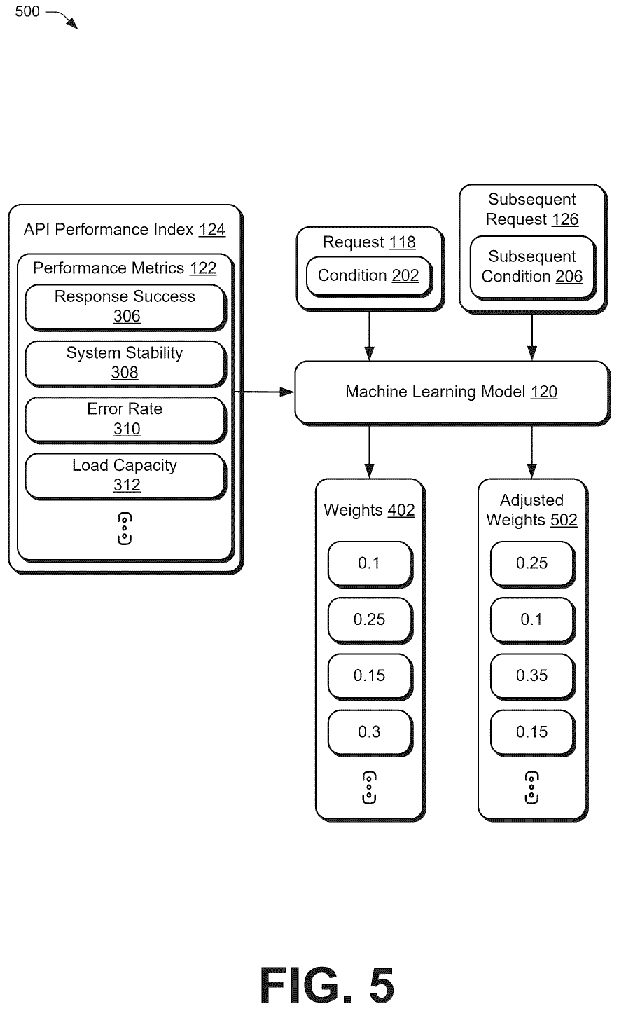

FIG. 5 depicts an example 500 of adjusting weights for performance metrics for API recommendations. Example 500 is a continuation of the example 400 described with respect to FIG. 4. After the API recommendation system 106 uses the machine learning model 120 to generate the weights 402 corresponding to the performance metrics 122, the API recommendation system 106 uses the machine learning model 120 to generate adjusted weights 502.

In the illustrated example 500, the performance metrics 122 include response success 306, system stability 308, error rate 310, and load capacity 312 related to recorded events involving performance of a request 118 by a first API 204. Different requests vary depending on conditions of the different requests. Based on the condition 202 of the request 118, the API recommendation system 106 determines the weights 402 corresponding to the performance metrics 122 that indicate a level or relevance or importance for the performance metrics 122.

In this example, the condition 202 of the request 118 calls for storing data files of a certain size. Based on the condition 202, the machine learning model 120 determines that the request 118 involves a Database API. Because the request involves the Database API, the machine learning model 120 ranks the system stability 308 and the load capacity 312 as more relevant than the response success 306 and the error rate 310 of the performance metrics 122. In this example, the machine learning model 120 assigns the weights 402 to the performance metrics 122, including 0.1 for the response success 306, 0.25 for the system stability 308, 0.15 for the error rate 310, and 0.3 for the load capacity 312, based on determined relative levels of importance.

The subsequent condition 206 of the subsequent request 126 calls for collecting payment information from a customer. Based on the subsequent condition 206, the machine learning model 120 determines that the subsequent request 126 involves a Payment API. Because the subsequent request 126 involves the Payment

API, the machine learning model 120 ranks the response success 306 and the error rate 310 as more relevant than the system stability 308 and the load capacity 312 of the performance metrics 122. In this example, the machine learning model 120 assigns the adjusted weights 502 to the performance metrics 122, including 0.25 for the response success 306, 0.1 for the system stability 308, 0.35 for the error rate 310, and 0.15 for the load capacity 312, based on determined relative levels of importance.

Comparing the weights 402 associated with the condition 202 of the request 118 with the adjusted weights 502 associated with the subsequent condition 206 of the subsequent request 126, the machine learning model 120 learns insights regarding relevancy of different metrics of the performance metrics 122 to the request 118 compared to the subsequent request 126. For instance, the response success 306 is more relevant to the subsequent request 126 than the request 118, the system stability 308 is more relevant to the request 118 than the subsequent request 126, the error rate 310 is more relevant to the subsequent request 126 than the request 118, and the load capacity 312 is more relevant to the request 118 than the subsequent request 126. Based on the insights, the machine learning model 120 then selects the second API 208 to perform the subsequent request 126. As part of this, the machine learning model 120 determines whether to call the first API 204 a second time to perform the subsequent request 126, or to call a different API for the second API 208.

For example, the first API 204 has high metrics for the system stability 308 and the load capacity 312, and low metrics for the response success 306 and the error rate 310. This makes the first API 204 ideal for performing the request 118, which has the weights 402 corresponding to the system stability 308 and the load capacity 312 as weighted higher than the response success 306 or the error rate 310. However, because the adjusted weights 502 corresponding to the subsequent request 126 has the response success 306 and the error rate 310 as weighted higher than the system stability 308 and the load capacity 312, first API 204 is not ideal. Therefore, the machine learning model 120 determines a different API for the second API 208 that is predicted to perform better for the response success 306 and the error rate 310 metrics.

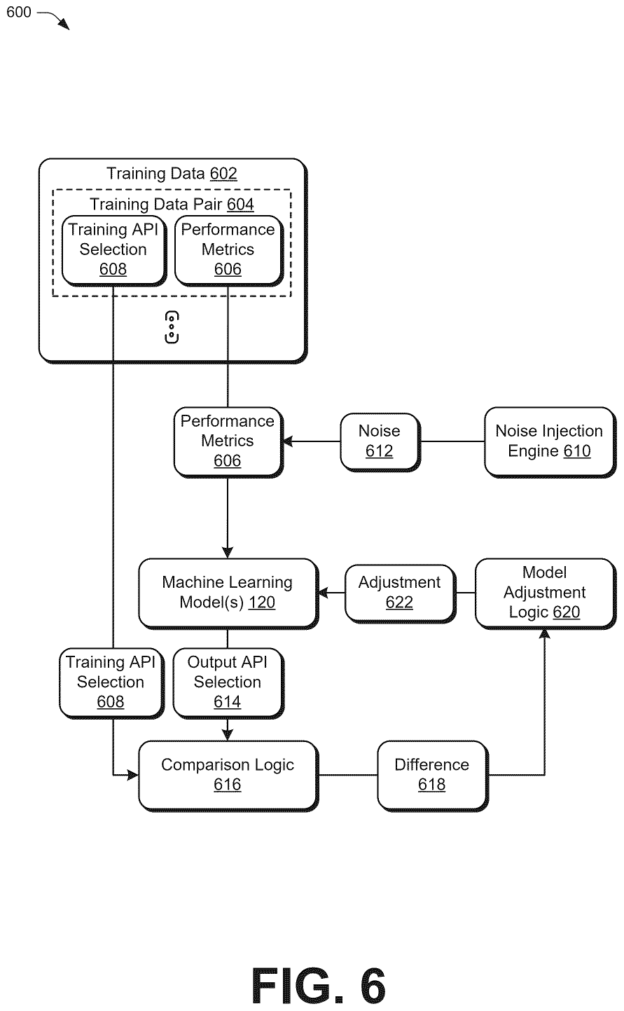

FIG. 6 depicts an example 600 of training one or more machine learning models for API recommendations based on performance metrics. The machine learning model 120 utilizes algorithms to learn from, and make predictions on, known data by analyzing training data 602 to learn and relearn to generate outputs that reflect patterns and attributes of the training data 602. Examples of machine-learning models include neural networks, convolutional neural networks (CNNs), long short-term memory (LSTM) neural networks, generative adversarial networks (GANs), decision trees, support vector machines, linear regression, logistic regression, reinforcement learning, Bayesian networks, random forest learning, dimensionality reduction algorithms, boosting algorithms, deep learning neural networks, and so forth.

The plurality of layers is configurable to include an input layer, an output layer, and one or more hidden layers. Calculations are performed within the layers via hidden states through a system of weighted connections that are “learned” during training of the machine learning model 120. The machine learning model 120 is trained on training data 602 including a training data pair 604. The training data pair 604 includes performance metrics 606 and a training API selection 608. The performance metrics 606 are collected from the performance metrics 122 of the API performance index 124. For example, the performance metrics 606 include measured event data related to performance of a request by an API.

A noise injection engine 610 injects noise 612 into the performance metrics 606. For example, the noise 612 is Gaussian Noise or other distribution to inject noise, including Poisson Noise. In some examples, injecting the noise 612 includes distorting the data associated with the performance metrics 606.

The machine learning model 120 receives the performance metrics 606 and generates an output API selection 614 indicating an API to perform a request based on the performance metrics 606. Comparison logic 616 of the machine learning model 120 receives the training API selection 608 corresponding to the performance metrics 606 from the training data 602. Because the training API selection 608 is a ground truth, or “correct” label, for the performance metrics 606, the comparison logic 616 computes a difference 618 between the output API selection 614 and the training API selection 608. In some examples, computing the difference 618 includes calculating a loss function to quantify a loss associated with operations performed by the machine learning model 120 in generating the output API selection 614. The loss function is configurable in a variety of ways, examples of which include cross-entropy loss, regret, Quadratic loss function as part of a least squares technique, perceptual loss using a pre-trained convolutional neural network, and so forth.

Based on the difference 618, a model adjustment logic 620 of the machine learning model 120 generates an adjustment 622 or multiple adjustments to the machine learning model 120. For example, the model adjustment logic 620 uses a backpropagation operation as part of minimizing the loss function and thereby training parameters of the machine learning model 120. Minimizing the loss function, for instance, includes adjusting weights corresponding to labeling logic to minimize the loss and thereby optimize performance of the machine learning model 120. The adjustment is determined by computing a gradient of the loss function, which indicates a direction to be used in order to adjust the parameters to minimize the loss. The parameters of the machine learning model 120 are then updated based on the computed gradient.

This process of training the machine learning model 120 continues over a plurality of iterations in an example until satisfying one or more stopping criterion. The stopping criterion is employed by the API recommendation system 106 in this example to reduce overfitting of the machine learning model 120, reduce computational resource consumption, and promote an ability of the machine learning model 120 to address previously unseen data (e.g., data that is not included specifically as an example in the training data 602). Examples of a stopping criterion include but are not limited to a predefined number of epochs, validation loss stabilization, achievement of a performance improvement threshold, or based on performance metrics such as precision and recall. In this example, the backpropagation operation continues training the machine learning model 120 until the output API selection 614 converges with the training API selection 608.

In an example, the machine learning model 120 includes a gradient boosting decision tree, where a tree is constructed to correct errors of its predecessor. The gradient boosting decision tree captures complex nonlinear patterns in data, predicting API performance based on historical data. Features of the gradient boosting decision trees include historical performance metrics, API stability metrics, response times, error rates, and other custom metrics, including cost-effectiveness. The gradient boosting decision tree targets optimal API selection based on past performance. Periodic training for the gradient boosting decision tree occurs as new data becomes available, depending on data volume and variability of signal sources.

In an additional example, the machine learning model 120 is a deep neural network that learns from high-level abstractions in data through multiple layers of processing to model complex relationships in data. Features of the deep neural network include raw or processed metrics from APIs, and the deep neural network is additionally capable of also incorporating textual or unstructured data. The deep neural network targets a continuous output that dictates a weight of each API during decision making.

Having discussed exemplary details of API recommendations based on performance metrics, consider now some examples of procedures to illustrate additional aspects of the techniques.

### Example Procedures

This section describes examples of procedures for API recommendations based on performance metrics. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

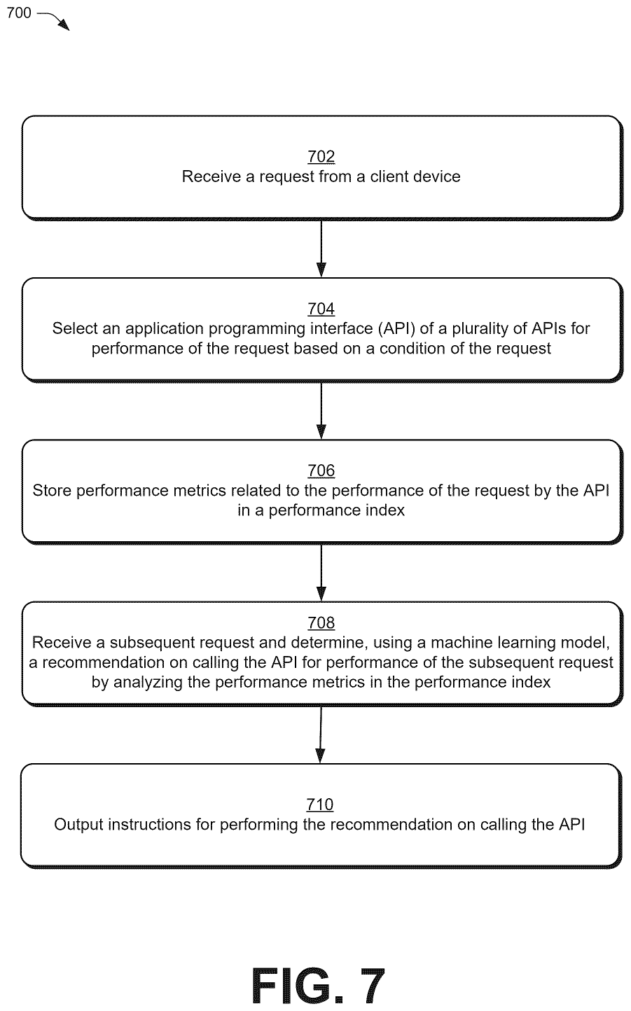

FIG. 7 depicts a procedure 700 in an example implementation of API recommendations based on performance metrics. A request 118 from a client device 102 is received (block 702). In some examples, the request 118 from the client device indicates performance of an action by an application programming interface (API).

An API of a plurality of APIs is selected for performance of the request 118 based on a condition 202 of the request 118 (block 704). Some examples further comprise determining a type of the API based on the condition 202 of the request 118. For example, the type of the API indicates parameters for performance of the action by the API.

Performance metrics 122 related to the performance of the request 118 are stored by the API in a performance index (block 706). For example, the performance metrics 122 measure response success 306, system stability 308, error rate 310, or load capacity 312 related to the performance of the request 118 by the API. Some examples further comprise analyzing events related to the performance of the request 118 by the API to capture the performance metrics 122.

A subsequent request 126 is received (block 708). For example, the subsequent request indicates performance of a subsequent action by the API or an additional API. A recommendation on calling the API for performance of the subsequent request 126 by is determined using a machine learning model 120 by analyzing the performance metrics 122 in the performance index (block 710). In some examples, the machine learning model 120 adjusts weights 402 of the performance metrics based on a condition of the subsequent request 126. For example, the machine learning model 120 is trained on selections of APIs based on varied weights of the performance metrics 122 for performance of previous requests. In some examples, the recommendation on calling the API is based on a comparison between a condition of the subsequent request 126 and the type of the API. Additionally or alternatively, the recommendation on calling the API is based on a composite score of the performance metrics 122 in the performance index.

Instructions are output for performing the recommendation on calling the API (block 712). Some examples further comprise updating the recommendation on calling the API for the performance of the subsequent request based on detecting whether the performance of the subsequent request meets a threshold level of performance.

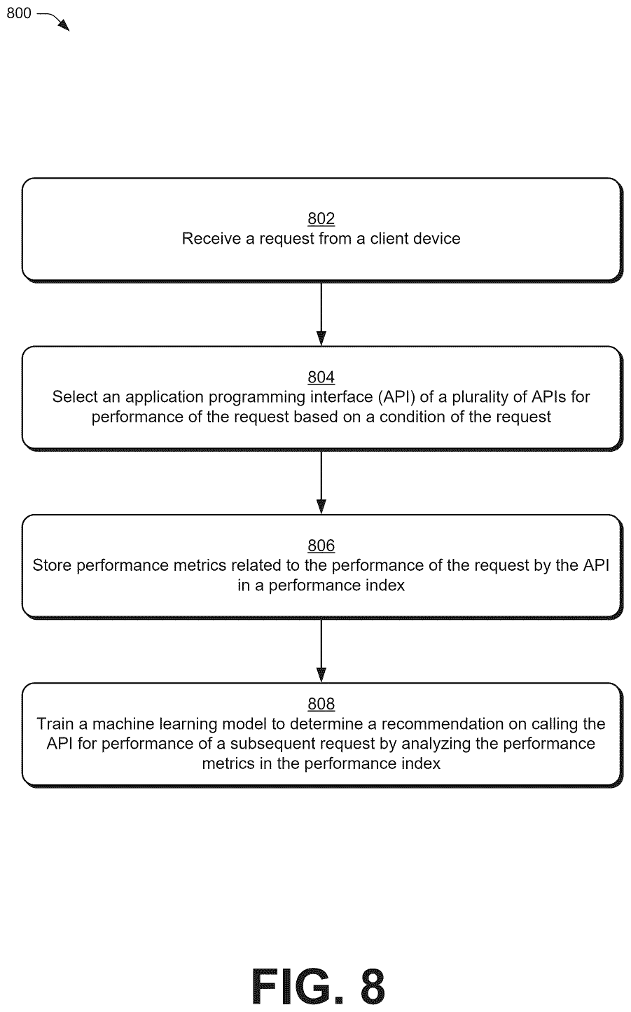

FIG. 8 depicts a procedure 800 in an example implementation of API recommendations based on performance metrics. A request 118 from a client device 102 is received (block 802). For example, the request 118 from the client device indicates performance of an action by an application programming interface (API). An API of a plurality of APIs is selected for performance of the request 118 based on a condition 202 of the request 118 (block 804). Some examples further comprise determining a type of the API based on the condition 202 of the request 118.

Performance metrics 122 related to the performance of the request 118 by the API are stored in a performance index (block 806). For example, the performance metrics 122 measure response success 306, system stability 308, error rate 310, or load capacity 312 related to the performance of the request 118 by the API. Some examples further comprise analyzing events related to the performance of the request by the API to capture the performance metrics 122.

A machine learning model 120 is trained to determine a recommendation on calling the API for performance of a subsequent request 126 by analyzing the performance metrics 122 in the performance index (block 808). Some examples further comprise training the machine learning model 120 to adjust weights 402 of the performance metrics 122 based on a condition 202 of the subsequent request 126. Additionally or alternatively, some examples further comprise training the machine learning model 120 on selections of APIs based on varied weights of the performance metrics for performance of previous requests. In some examples, the recommendation on calling the API is based on a composite score of the performance metrics 122 in the performance index.

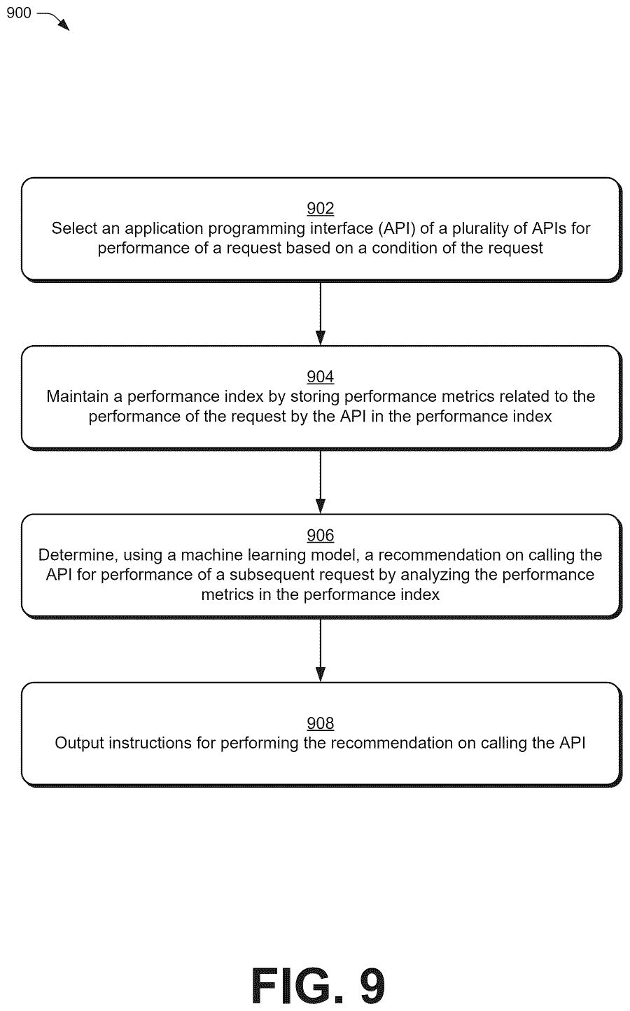

FIG. 9 depicts a procedure 900 in an example implementation of API recommendations based on performance metrics. An application programming interface (API) of a plurality of APIs is selected for performance of a request 118 based on a condition 202 of the request 118 (block 902). For example, the request 118 from the client device indicates performance of an action by an API.

A performance index is maintained by storing performance metrics 122 related to the performance of the request 118 by the API in the performance index (block 904). For example, the performance metrics 122 measure response success, system stability, error rate, or load capacity related to the performance of the request by the API. In some examples, the performance metrics 122 are determined by analyzing event data related to performance of the request by the API.

A recommendation on calling the API for performance of a subsequent request 126 is determined using a machine learning model 120 by analyzing the performance metrics 122 in the performance index (block 906). In some examples, the machine learning model 120 adjusts weights of the performance metrics 122 based on a condition of the subsequent request 126. Additionally or alternatively, the machine learning model 120 is trained on selections of APIs based on varied weights of the performance metrics 122 for performance of previous requests.

Instructions are output for performing the recommendation on calling the API (block 908). Some examples further comprise updating the recommendation on calling the API for the performance of the subsequent request 126 based on detecting whether the performance of the subsequent request 126 meets a threshold level of performance.

Having described examples of procedures in accordance with one or more implementations, consider now an example of a system and device that can be utilized to implement the various techniques described herein.

### Example System and Device

FIG. 10 illustrates an example of a system generally at 1000 that includes an example of a computing device 1002 that is representative of one or more computing systems and/or devices that may implement the various techniques described herein. This is illustrated through inclusion of the vendor management platform 110 and the API recommendation system 106. The computing device 1002 may be, for example, a server of a service provider, a device associated with a client (e.g., a client device), an on-chip system, and/or any other suitable computing device or computing system.

The example computing device 1002 as illustrated includes a processing system 1004, one or more computer-readable media 1006, and one or more I/O interfaces 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware elements 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1006 is illustrated as including memory/storage 1012. The memory/storage 1012 represents memory/storage capacity associated with one or more computer-readable media. The memory/storage 1012 may include volatile media (such as random-access memory (RAM)) and/or nonvolatile media (such as read only memory (ROM), Flash memory, optical disks, magnetic disks, and so forth). The memory/storage 1012 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1002. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1002, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of a module that is executable by the computing device 1002 as software may be achieved at least partially in hardware, e.g., through use of computer-readable storage media and/or hardware elements 1010 of the processing system 1004. The instructions and/or functions may be executable/operable by one or more articles of manufacture (for example, one or more computing devices 1002 and/or processing systems 1004) to implement techniques, modules, and examples described herein.

The techniques described herein may be supported by various configurations of the computing device 1002 and are not limited to the specific examples of the techniques described herein. This functionality may also be implemented all or in part through use of a distributed system, such as over a “cloud” 1114 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 may include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 may abstract resources and functions to connect the computing device 1002 with other computing devices. The platform 1016 may also serve to abstract scaling of resources to provide a corresponding level of scale to encountered demand for the resources 1018 that are implemented via the platform 1016. Accordingly, in an interconnected device embodiment, implementation of functionality described herein may be distributed throughout the system 1000. For example, the functionality may be implemented in part on the computing device 1002 as well as via the platform 1016 that abstracts the functionality of the cloud 1014.

### Conclusion

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A method, comprising:
receiving a request from a client device;
selecting an application programming interface (API) of a plurality of APIs for performance of the request based on a condition of the request;
storing performance metrics related to the performance of the request by the API in a performance index;
receiving a subsequent request;
determining, using a machine learning model, a recommendation on calling the API for performance of the subsequent request by analyzing the performance metrics in the performance index; and
outputting instructions for performing the recommendation on calling the API.

2. The method of claim 1, wherein the machine learning model adjusts weights of the performance metrics based on a condition of the subsequent request.

3. The method of claim 1, wherein the machine learning model is trained on selections of APIs based on varied weights of the performance metrics for performance of previous requests.

4. The method of claim 1, further comprising updating the recommendation on calling the API for the performance of the subsequent request based on detecting whether the performance of the subsequent request meets a threshold level of performance.

5. The method of claim 1, wherein the performance metrics measure response success, system stability, error rate, or load capacity related to the performance of the request by the API.

6. The method of claim 1, further comprising analyzing events related to the performance of the request by the API to capture the performance metrics.

7. The method of claim 1, further comprising determining a type of the API based on the condition of the request.

8. The method of claim 7, wherein the recommendation on calling the API is based on a comparison between a condition of the subsequent request and the type of the API.

9. The method of claim 1, wherein the recommendation on calling the API is based on a composite score of the performance metrics in the performance index.

10. A system comprising:
a memory component; and
a processing device coupled to the memory component, the processing device to perform operations comprising:
receiving a request from a client device;
selecting an application programming interface (API) of a plurality of APIs for performance of the request based on a condition of the request;
storing performance metrics related to the performance of the request by the API in a performance index; and
training a machine learning model to determine a recommendation on calling the API for performance of a subsequent request by analyzing the performance metrics in the performance index.

11. The system of claim 10, further comprising training the machine learning model to adjust weights of the performance metrics based on a condition of the subsequent request.

12. The system of claim 10, further comprising training the machine learning model on selections of APIs based on varied weights of the performance metrics for performance of previous requests.

13. The system of claim 10, wherein the performance metrics measure response success, system stability, error rate, or load capacity related to the performance of the request by the API.

14. The system of claim 10, further comprising analyzing events related to the performance of the request by the API to capture the performance metrics.

15. The system of claim 10, further comprising determining a type of the API based on the condition of the request.

16. The system of claim 10, wherein the recommendation on calling the API is based on a composite score of the performance metrics in the performance index.

17. A non-transitory computer-readable storage medium storing executable instructions, which when executed by a processing device, cause the processing device to perform operations comprising:
selecting an application programming interface (API) of a plurality of APIs for performance of a request based on a condition of the request;
maintaining a performance index by storing performance metrics related to the performance of the request by the API in the performance index;
determining, using a machine learning model, a recommendation on calling the API for performance of a subsequent request by analyzing the performance metrics in the performance index; and
outputting instructions for performing the recommendation on calling the API.

18. The non-transitory computer-readable storage medium of claim 17, wherein the machine learning model adjusts weights of the performance metrics based on a condition of the subsequent request.

19. The non-transitory computer-readable storage medium of claim 17, wherein the machine learning model is trained on selections of APIs based on varied weights of the performance metrics for performance of previous requests.

20. The non-transitory computer-readable storage medium of claim 17, further comprising updating the recommendation on calling the API for the performance of the subsequent request based on detecting whether the performance of the subsequent request meets a threshold level of performance.
